(19) United States
(12) Patent Application Publication
(10) Pub. No.: US 2017/0310988 A1
(43) Pub. Date: Oct. 26, 2017

(54) Method of Motion Vector Predictor or Merge Candidate Derivation in Video Coding

(71) Applicant: MEDIATEK INC., Hsin-Chu (TW)

(72) Inventors: Jian-Liang LIN, Su'ao Township, Yilan County (TW); Yi-Wen CHEN, Taichung City (TW)

(21) Appl. No.: 15/526,083

(22) PCT Filed: Dec. 9, 2015
(86) PCT No.: PCT/CN2015/096762

§ 371 Date: May 11, 2017

Related U.S. Application Data
(60) Provisional application No. 62/089,352, filed on Dec. 9, 2014.

(51) Int. Cl. H04N 19/513; H04N 19/56

(52) U.S. Cl. CPC H04N 19/513; H04N 19/56

(57) ABSTRACT

A method and apparatus for deriving directional-priority based candidates for a block coded in Inter, or Merge or Skip mode are disclosed. One or more motion vectors associated with one or more previously coded blocks for a current block are determined first. One or more directional-priority based candidates for the current block are derived by searching through the previously coded blocks according to a priority order associated with prediction direction of the motion vectors. The motion vectors having a first prediction direction are selected with a higher priority than the motion vectors having a second prediction direction. The derived directional-priority based candidates are inserted into a candidate list. The motion vector predictor (MVP) or Merge/Skip candidate is selected from the candidate list for coding the current block in Inter, or Merge or Skip mode.

### CROSS REFERENCE TO RELATED APPLICATIONS

The present invention claims priority to U.S. Provisional Patent Application Ser. No. 62/089,352, filed on Dec. 9, 2014. The U.S. Provisional Patent Application is hereby incorporated by reference in its entirety.

### TECHNICAL FIELD

The present invention relates to video coding. In particular, the present invention relates to motion vector predictor or Merge candidate derivation in video coding.

### BACKGROUND

The advances of digital video coding standards have resulted in successes of multimedia systems such as smartphones, digital TVs, and digital cameras for the past decade. After standardization activities of H.261, MPEG-1, MPEG-2, H.263, MPEG-4, and H.264/AVC, the demand for improving video compression performance was still strong due to requirements of larger picture resolutions, higher frame rates and better video qualities. Therefore, efforts in developing new video coding techniques to improve coding efficiency over H.264/AVC continue. HEVC is based on a hybrid block-based motion-compensated transform coding architecture. The basic unit for compression is termed coding tree unit (CTU). Each CTU may contain one coding unit (CU) or recursively split into four smaller CUs until the predefined minimum CU size is reached. Each CU (also named leaf CU) contains one or multiple prediction units (PUs) and a tree of transform units (TUs).

In general, a CTU consists of one luma coding tree block (CTB) and two corresponding chroma CTBs, a CU consists of one luma coding block (CB) and two corresponding chroma CBs, a PU consists of one luma prediction block (PB) and two corresponding chroma PBs, and a TU consists of one luma transform block (TB) and two corresponding chroma TBs. However, exceptions can occur because the minimum TB size is 4×4 for both luma and chroma (i.e., no 2×2 chroma TB allowed for 4:2:0 color format) and each Intra chroma CB always has only one Intra chroma PB regardless of the number of Intra luma PBs in the corresponding Intra luma CB.

For an Intra CU, the luma CB can be predicted as one PB, or partitioned into four luma PBs and predicted as individual PBs. For the two chroma CBs, each is always predicted by one chroma PB. While each luma PB has one Intra luma prediction mode, the two chroma PBs share one Intra chroma prediction mode. Moreover, for the Intra CU, the TB size is restricted to be no larger than the PB size. In each PB, the Intra prediction is applied to predict samples of each TB inside the PB from neighboring reconstructed samples of the TB. For each PB, in addition to 33 directional Intra prediction modes, DC and planar modes are also supported to predict flat regions and gradually varying regions, respectively.

For each Inter PU, one of three prediction modes including Inter, Skip, and Merge, can be selected. Generally speaking, a motion vector competition (MVC) scheme is introduced to select a motion candidate from a given candidate set that includes spatial and temporal motion candidates. Multiple references to the motion estimation allow finding the best reference in two possible reconstructed reference picture lists (i.e., list 0 and list 1). For the Inter mode, advanced motion vector prediction (AMVP) has been developed to derive a motion vector prediction candidate based on coded neighboring blocks. Accordingly, the Inter mode is also referred as AMVP mode. For an Inter-coded CU, Inter prediction indicators (i.e., list 0, list 1, or bi-directional prediction), reference indices, motion candidate indices, motion vector differences (MVDs) and prediction residual are transmitted. For the Skip mode and the Merge mode, only Merge indices are transmitted, and the current PU inherits the Inter prediction indicator, reference indices, and motion vectors from a neighboring PU referred by the coded Merge index. In the case of a Skip coded CU, the residual signal is also omitted. Quantization, entropy coding, and deblocking filter (DF) are also in the coding loop of HEVC. The basic operations of these three modules are similar to those used in H.264/AVC.

Sample adaptive offset (SAO) is a new in-loop filtering technique adopted in HEVC, which is applied after deblocking filter (DF). SAO is aimed to reduce sample distortion by classifying deblocked samples into different categories and then adding an offset to deblocked samples of each category.

Competitive Spatial-Temporal Motion Candidate in Inter Prediction

There are three prediction modes for the Inter prediction in HEVC, including the Inter mode, Skip mode and Merge mode. In order to increase the coding efficiency of the MV prediction and MV coding, a motion vector competition (MVC) scheme is applied to select one motion candidate among a given candidate list containing spatial and temporal motion candidates. The MVC scheme is applied for all the three modes.

For the Inter mode, an Inter prediction indicator is transmitted to denote list 0 prediction, list 1 prediction, or bi-prediction. Next, one or two reference indices are transmitted when there are multiple reference pictures. An index is transmitted for each prediction direction to select one motion candidate from the candidate list. As shown in FIG. 1, the candidate list for the Inter mode includes two spatial motion candidates and one temporal motion candidate:

1. Left candidate (the first available from A₀ and A₁),

2. Top candidate (the first available from B₀, B₁ and B₂), and

3. Temporal candidate (the first available from T_{BR} and T_{CT}).

The left spatial motion candidate is searched from the below-left block to the bottom-left block (i.e., from A₀ to A₁) and the first available one is selected as the left candidate. The top spatial motion candidate is searched from the above-right block to the above-left (i.e., B₀, B₁ and then B₂) and the first available one is selected as the top candidate. A temporal motion candidate is derived from a block (T_{BR} or T_{CT}) located in a reference picture, which is termed as temporal collocated picture. The temporal collocated picture is indicated by transmitting one flag in slice header to specify the reference picture list and one reference index used as the collocated reference picture. After the index is transmitted, one or two corresponding motion vector differences (MVDs) are transmitted.

For the Skip mode and Merge mode, a Merge index is signaled to indicate which candidate in the merging candidate list is used. No Inter prediction indicator, reference index, or MVD is transmitted. Each PU of the Skip or Merge mode reuses the Inter prediction indicator, reference index (or indices), and motion vector(s) of the selected candidate. It is noted that if the selected candidate is a temporal motion candidate, the reference index is always set to 0. As shown in FIG. 1, the merging candidate list for the Skip mode and the Merge mode includes four spatial motion candidates and one temporal motion candidate:
1. Bottom left candidate (A₁),
2. Right top candidate (B₁),
3. Above right candidate (B₀),
4. Below left candidate (A₀),
5. Above left candidate (B₂), used only when any of the above spatial candidate is not available, and
6. Temporal candidate (the first available from T_{BR} and T_{CT}).

Redundancy Removal and Additional Motion Candidates

For the Inter mode, Skip mode, and Merge mode, after deriving the spatial motion candidates, a pruning process is performed to check the redundancy among the spatial candidates.

After removing redundant or unavailable candidates, the size of the candidate list can be adjusted dynamically at both the encoder and decoder sides so that the truncated unary binarization can be beneficial for entropy coding of the index. Although the dynamic size of candidate list may improve coding gains, it also introduces a parsing problem. When the temporal motion candidate is included in the candidate list and if one MV of a previous picture cannot be decoded correctly, a mismatch between the candidate lists on the encoder side and the decoder side may occur, which may result in a parsing error of the candidate index. This parsing error can propagate and cause severe impact on video quality since the rest of the current picture cannot be parsed or decoded properly. Furthermore, this parsing error can affect subsequent Inter pictures that may use temporal motion candidates. Therefore, one small decoding error of a MV may cause parsing failures of many subsequent pictures.

In HEVC, in order to solve the mentioned parsing problem, a fixed candidate list size is used to decouple the candidate list construction and the parsing of the index. Moreover, in order to compensate the coding performance loss caused by the fixed list size, additional candidates are assigned to the empty positions in the candidate list. In this process, the index is coded in truncated unary codes of a maximum length. According to HEVC, the maximum length is transmitted in slice header for the Skip mode and Merge mode, and the maximum length is fixed to 2 for the Inter mode.

For the Inter mode, a zero vector motion candidate is added to fill the empty positions in the AMVP candidate list after the deriving and pruning of the two spatial motion candidates and the one temporal motion candidate. As for the Skip mode and Merge mode, after the deriving and pruning of the four spatial motion candidates and the one temporal motion candidate, if the number of available candidates is smaller than the fixed candidate list size, additional candidates are derived and added to fill the empty positions in the merging candidate list.

Two types of additional candidates are used to fill the merging candidate list: the combined bi-predictive motion candidate and the zero vector motion candidate. The combined bi-predictive motion candidates are created by combining two original motion candidates according to a predefined order. After adding the combined bi-predictive motion candidates, if the merging candidate list still has one or more empty positions, one or more zero vector motion candidates are added to the remaining positions.

The AMVP scheme has been shown to improve coding efficiency over the conventional MVP approach, which may be a single candidate corresponding to the last coded MV of a neighboring block. It is desirable to develop new MVP schemes to further improve the performance for Inter, Merge or Skip coding mode.

### SUMMARY

A method and apparatus for deriving directional-priority based candidates for a block coded in Inter, or Merge or Skip mode are disclosed. According to one embodiment, one or more motion vectors associated with one or more previously coded blocks for a current block are determined. One or more directional-priority based candidates for the current block are derived by searching through the previously coded blocks according to a priority order associated with prediction direction of the motion vectors. The motion vectors associated with the previously coded blocks having a first prediction direction are selected with a higher priority than the motion vectors associated with the previously coded blocks having a second prediction direction. The derived directional-priority based candidates are inserted into a candidate list. The motion vector predictor (MVP) or Merge/Skip candidate is selected from the candidate list for coding the current block in Inter, or Merge or Skip mode.

In one embodiment, the directional-priority based candidate is a first available bi-directional candidate within a searching range.

The previously coded blocks may comprise one or more top neighboring blocks in a top boundary of the current block, one or more left neighboring blocks in a left boundary of the current block, or both. The directional-priority based candidates may comprise one or more top directional-priority based candidates derived from the top neighboring blocks, one or more left directional-priority based candidates derived from the left neighboring blocks, or both. For example, the top directional-priority based candidates are derived by searching the top neighboring blocks from right to left or from left to right. Also, the search can be from a center top neighboring block toward both end top neighboring blocks in an alternated manner. In another example, the left directional-priority based candidates are derived by searching the left neighboring blocks from top to bottom or from bottom to top. Also, the search can be from a center left neighboring block toward both end top neighboring blocks in an alternated manner.

The directional-priority based candidates may comprise one top directional-priority based candidate derived from the top neighboring blocks and one left directional-priority based candidate derived from the left neighboring blocks. The top neighboring blocks may correspond to a single center top neighboring block in a center top boundary of the current block, and the left neighboring blocks may correspond to a single center left neighboring block in a center left boundary of the current block.

The prediction direction may comprise bi-direction, list-0 and list-1, and the priority order associated with the prediction direction corresponds to highest priority for the bi-direction, middle priority for the list-0 and lowest priority for the list-1.

The prediction direction may comprise bi-direction and uni-direction, and the first prediction direction is the bi-direction, while the second prediction direction is the uni-direction.

The method of the present invention may comprise inserting one or more spatial candidates, one or more temporal candidates, or both into the candidate list. The candidate list may comprise one top directional-priority based candidate derived from one or more top neighboring blocks of the current block, one left directional-priority based candidate derived from one or more left neighboring blocks of the current block, and five spatial candidates. The candidate list may further comprise four temporal candidates derived from collocated. The candidate list can be pruned before, during or after inserting spatial candidates, temporal candidates, or both into the candidate list to remove one or more redundant candidates.

Candidate indices for candidate members of the candidate list can be coded using context-adaptive binary arithmetic coding (CABAC). Each bin of the candidate indices can be context coded with an own probability status of each bin.

### BRIEF DESCRIPTION OF THE DRAWINGS

FIG. 1 illustrates an example of spatial and temporal neighboring block used to derive advanced motion vector prediction (AMVP) or Merge candidate list.

FIG. 2 illustrates an example of spatial and temporal neighboring block used to derive advanced motion vector prediction (AMVP) or Merge candidate list according to an embodiment of the present invention.

FIG. 3 illustrates an example of directional-priority based candidate derivation from a center top neighboring block and a center left neighboring block according to an embodiment of the present invention.

FIG. 4 illustrates an example of directional-priority based candidate derivation by searching left neighboring blocks in the left boundary in a search order from center left neighboring block toward two end blocks in an alternated fashion according to an embodiment of the present invention.

FIG. 5 illustrates an example of directional-priority based candidate derivation by searching left neighboring blocks in the left boundary in a search order from two end blocks toward a center left neighboring block in an alternated fashion according to an embodiment of the present invention.

FIG. 6 illustrates an example of directional-priority based candidate derivation by searching left neighboring blocks in the left boundary in a search order from one end neighboring block to another end neighboring block according to an embodiment of the present invention.

FIG. 7 illustrates an example of left neighboring blocks in the left boundary and top neighboring blocks in the top boundary for deriving directional-priority based candidates according to an embodiment of the present invention.

FIG. 8 illustrates an exemplary flowchart of a coding system incorporating directional-priority based candidate derivation for Inter, Merge or Skip mode according to an embodiment of the present invention.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

While the advanced motion vector prediction (AMVP) schedule has shown to improve coding efficiency, the present invention discloses method and apparatus to further improve the performance over the AMVP scheme. However, the disclosed candidate derivation can be applied to other video coding applications, where motion vector predictor (MVP) candidates need to be derived. Accordingly, directional-priority based methods to derive the motion vector predictor (MVP) or Merge candidate for Skip, Merge, Direct and/or Inter modes are disclosed in this invention to improve the coding efficiency.

According to the directional-priority based spatial/temporal Merge candidate (or MVP) derivation, the candidate is searched from one or more blocks with a given priority associated with prediction direction. The prediction direction refers to bi-direction, list 0 and list 1 in the Inter prediction mode. A motivation of the present invention is based on the observation that these prediction directions may have different impact on the coding performance. For example, the bi-direction motion vectors may result in better prediction result since it uses two reference blocks in two different directions (i.e., list 0 and list 1). If this first choice is not available, the next choice will be sought. For example, list 0 candidate may be searched as the next choice since it is in the same reference list. An exemplary derivation process is disclosed as follows:
Search first N (N equal to a positive integer) available bi-directional candidate within the searching range (i.e., searching blocks). Once the first up-to-N available candidates/MVPs are found, they are used to derive the Merge candidate (or MVP).
If less than N candidates can be derived from the previous step, continue searching remaining number of N candidates from first available uni-directional list-0 candidates within the searching range. Once the first up-to-N available candidates/MVPs are found, they are used to derive the Merge candidate (or MVP).
If still less than N candidates can be derived from the previous steps, continue searching remaining number of N candidates from first available uni-directional list-1 candidates within the searching range. Once the first up-to-N available candidates/MVPs are found, they are used to derive the Merge candidate (or MVP).

In the above example, the given directional priority order is bi-direction→list 0→list 1 (i.e., bi-direction corresponds to the highest priority, list 0 corresponds to the middle priority, and list 1 corresponds to the lowest priority). However, the present invention is not limited to the particular directional priority order shown in the above example. Other directional priority orders such as bi-direction→list 1→list 0, list 0→list 1 bi-direction or list 1→list 0→bi-direction can also be used. In the other example, the directional priority orders could also depend on a given target reference list such as bi-direction given target reference list the other reference list.

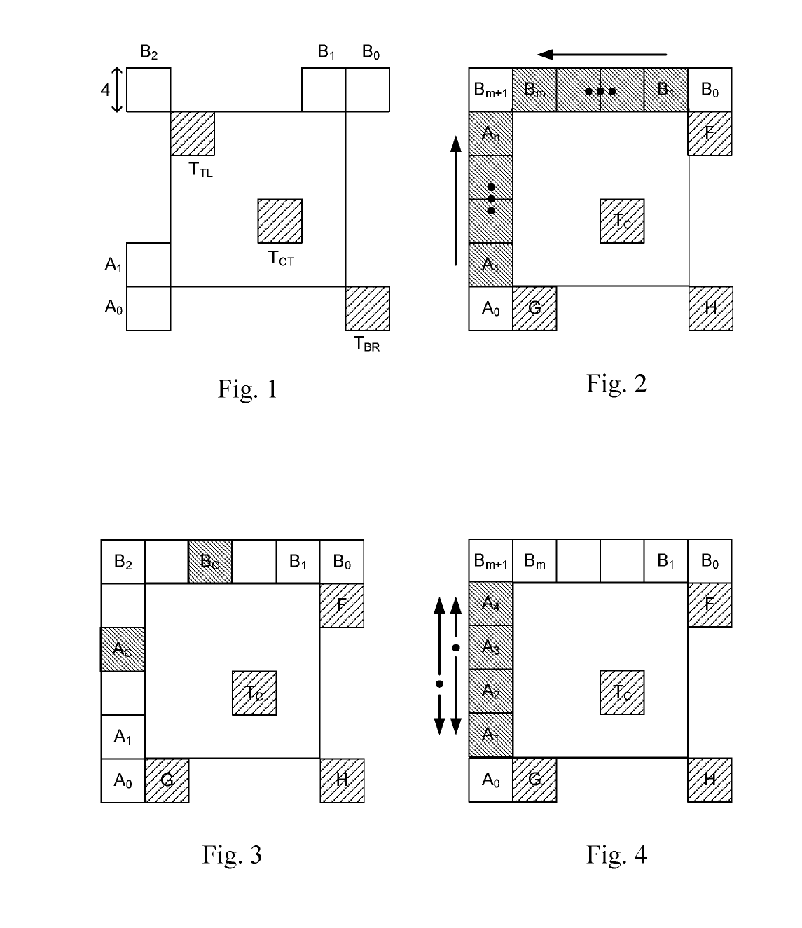

FIG. 2 illustrates an example of directional-priority based spatial candidate derivation according to an embodiment of the present invention. The derivation process for the MVP or Merge candidate is described as follows:
Search N left spatial candidates from A₁ to Aₙ
   Search first N (N equal to a positive integer) available bi-direction candidate from A₁ to Aₙ. Once the first up-to-N available candidates/MVPs are found, they are used to derive the Merge candidate (or MVP).
   If less than N candidates can be derived from the previous step, continue searching remaining number of N candidates from first available uni-prediction list-0 candidates from A₁ to Aₙ. Once the up-to-N first available candidates/MVPs are found, they are used to derive the Merge candidate (or MVP).
   If still less than N candidates can be derived from the previous steps, continue searching remaining number of N candidates from first available uni-prediction list-1 candidates from A₁ to Aₙ. Once the first up-to-N available candidates/MVPs are found, they are used to derive the Merge candidate (or MVP).
Search N top spatial candidates from B₁ to Bₘ
   Search first N (N equal to a positive integer) available bi-direction candidate from B₁ to Bₘ. Once the first up-to-N available candidates/MVPs are found, they are used to derive the Merge candidate (or MVP).
If less than N candidates can be derived from the previous step, continue searching remaining number of N candidates from first available uni-prediction list-0 candidates from B₁ to Bₘ. Once the first up-to-N available candidates/MVPs are found, they are used to derive the Merge candidate (or MVP).
If still less than N candidates can be derived from the previous steps, continue searching remaining number of N candidates from first available uni-prediction list-1 candidates from B₁ to Bₘ. Once the first up-to-N available candidates/MVPs are found, they are used to derive the Merge candidate (or MVP).

In the above example, N left spatial candidates are designated as the directional-priority based candidates derived from the left blocks from A₁ to Aₙ. Similarly, N top spatial candidates are designated as the directional-priority based candidates derived from the top blocks from B₁ to Bₘ. While spatial neighboring blocks B₁, B₂, . . . , Bₘ in the top boundary (also referred to as “above boundary”) and spatial neighboring blocks A₁, A₂, . . . , Aₙ in the left boundary of the current block are used to derive the directional-priority based candidates in the above example, other blocks from spatial neighboring block and/or temporal collocated blocks in corresponding temporal reference pictures may also be used. For example, only the spatial neighboring blocks in the top boundary or only the spatial neighboring blocks in the left boundary are used to derive the directional-priority based candidates. While all neighboring blocks in the top boundary or all neighboring blocks in the left boundary are used to derive the directional-priority based candidates in the above example, partial neighboring block(s) may also be used. Furthermore, the spatial neighboring blocks may be selected beyond the spatial neighboring blocks shown in FIG. 2. Furthermore, in the above example, individual directional-priority based candidates are derived for the neighboring blocks in the top boundary and the neighboring blocks in the left boundary respectively. However, directional-priority based candidates may also be derived from the top neighboring blocks in the top boundary and the left neighboring blocks in the left boundary jointly.

FIG. 3 illustrates another embodiment of the present invention, where two new spatial candidates including one from the center of the left boundary and another one from the center of the above boundary are derived. Accordingly, the spatial candidates and the temporal candidates include:
5+2 spatial candidates (A_{c}, B_{c}, A₁, A₀, B₁, B₀, B₂), and
4 temporal candidates (H, T_{c}, F, G).

The two additional candidates A_{c} and B_{c} can be inserted in the first two positions of the candidate list as shown above. The list size can be L, where L is a positive integer number (e.g. 7). The first L available candidates from the {5+2 spatial candidate and 4 temporal candidates} are included into the candidate list. Pruning process may be applied before, during or after inserting the additional candidates to the candidate list so as to remove all or a portion of redundant candidates. If the list contains less than L candidates, default candidate(s) may be inserted. If more than L candidates in the list, only the first L candidates will be used. While the two additional candidates A_{c} and B_{c} are inserted in the first two positions of the candidate list in the above example, they can be inserted in any positions in the list as well.

In another embodiment of the present invention, the two new spatial candidates from the center of the left boundary and the center of the above boundary are derived by searching the left boundary and the above boundary starting from respective center. For example, as shown in the FIG. 4, the searching order of the left spatial candidates can be (A₃→A₂→A₄→A₁) or (A₂→A₃→A₁→A₄). In other words, the search order corresponds to search from a center location toward both ends in an alternated fashion. For example, the search order (A₃→A₂→A₄→A₁) corresponds to starting from a center position (i.e., A₃), searching downward (i.e., A₂), searching upward (i.e., A₄) and searching downward (i.e., A₁).

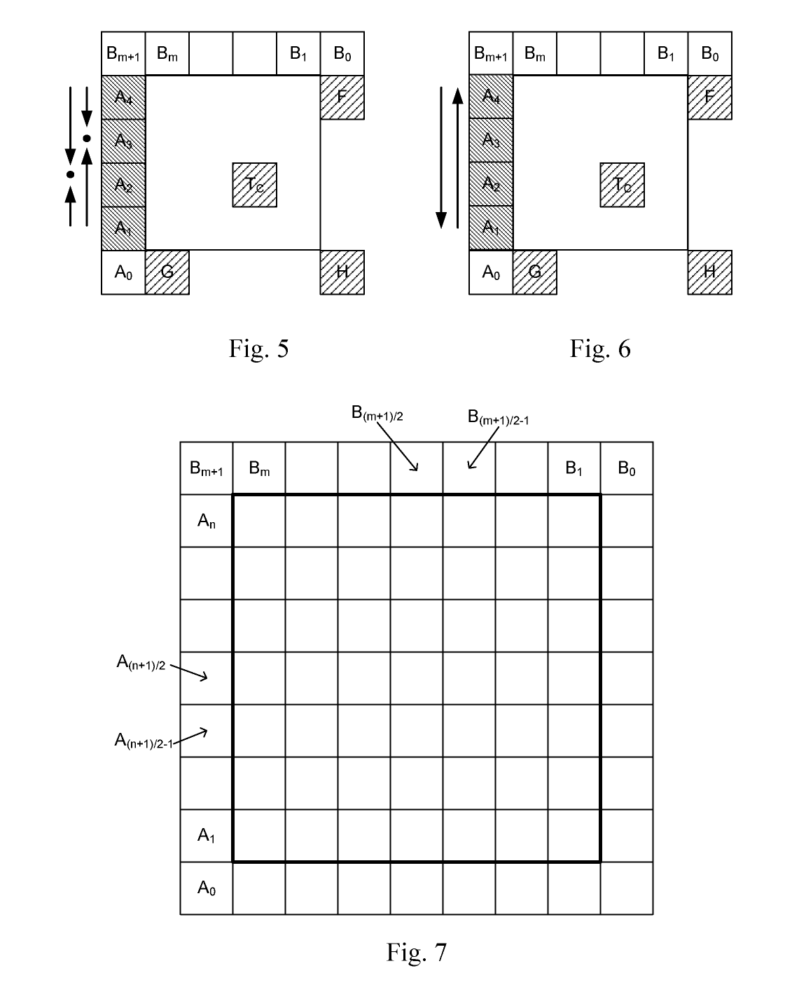

In yet another embodiment of the present invention, the two new spatial candidates from the center of the left boundary and the center of the above boundary are derived by searching the left boundary and the above boundary according to the directional-priority based candidate derivation. However, the searching order is from two end blocks toward center in an alternated fashion. For example, as shown in the FIG. 5, the searching order of the left spatial candidates is (A₁→A₄→A₂→A₃) or (A₄→A₁→A₃→A₂).

In yet another embodiment of the present invention, the two new spatial candidates from the left boundary and the above boundary are derived by searching the left boundary and the above boundary starting according to the directional-priority based candidate derivation. However, the searching order is from one end block toward another end block. For example, as shown in the FIG. 6, the searching order of the left spatial candidates is (A₁→A₂→A₃→A₄) or (A₄→A₃→A₂→A₁).

In the above embodiments associated with FIG. 3 through FIG. 5, the search through the neighboring blocks can use directional-priority based candidate derivation as mentioned previously. Furthermore, while the neighboring blocks in the left boundary of the current block are used as an example to derive MVP/Merge candidates, the neighboring block in the top boundary or both neighboring blocks in the top boundary and the left boundary may be used for deriving MVP/Merge candidates. Again, the directional-priority based candidate derivation can be applied to these neighboring blocks.

In another example, the two new spatial candidates from the left boundary and the above boundary are derived with the searching order started from a center block toward two end blocks of the boundary and with the directional priority order bi-prediction→list 0→list 1. Nevertheless, other directional priority orders may also be used to practice the present invention.

In yet another example, the two new spatial candidates derived from the left boundary and the above boundary are derived with the searching order started from A₁ to Aₙ or from B₁ to Bₘ (as illustrated in FIG. 2) and with the directional priority order bi-prediction→list 0→list 1. Nevertheless, other directional priority orders may also be used to practice the present invention.

In yet another example, the two new spatial candidates derived from the left boundary and the above boundary are derived with the searching order started from Aₙ to A₁ or from Bₘ to B₁, and with the directional priority order bi-prediction→list 0→list 1. Nevertheless, other directional priority orders may also be used to practice the present invention.

To improve the coding efficiency, the MVP index or Merge candidate index can be CABAC (context-adaptive binary arithmetic coding) coded and each bin is context coded with its own probability status. Each coded bin is context adaptive independently. As an example, the size of Merge candidate list is 7 and each bin is context coded independently.

In yet another embodiment of the present invention, N (N equal to a positive integer) left spatial MVPs or Merge candidates are derived from the left boundary until first N available candidates are found. As shown in FIG. 7, the searching order among the multiple blocks can be one of the following:

1. (A_{(n+1)/2-1}, A_{(n+1)/2}, . . . , A₁, Aₙ)

2. (A_{(n+1)/2-1}, A_{(n+1)/2}, . . . , A₁, Aₙ, A₀)

3. (A_{(n+1)/2}, A_{(n+1)/2-1}, . . . , Aₙ, A₁)

4. (A_{(n+1)/2}, A_{(n+1)/2-1}, . . . , Aₙ, A₁, A₀)

5. (A₁→ . . . →Aₙ)

6. (A₀, A₁→ . . . →Aₙ)

7. (Aₙ→ . . . →A₁)

8. (Aₙ→ . . . →A₀)

Alternatively, N (N equal to a positive integer) left spatial MVP(s) or Merge candidate(s) can be derived from the left boundary until first N available candidates are found with a given priority order. The searching order among multiple blocks can be one of the 8 searching orders illustrated above. The spatial MVP or Merge candidate search within the multiple searching blocks according the present invention is described as follows:
Search the first N (N equal to a positive integer) available bi-direction candidates among multiple blocks according to the searching order. Once up-to-N available candidate(s) are found, they are used to derive the Merge candidate (or MVP).
If less than N candidates can be derived from the previous step, continue searching remaining number of N candidates from first available uni-prediction list-0 candidates among multiple blocks according to the searching order. Once up-to-N available candidate(s) are found, they are used to derive the Merge candidate (or MVP).
If still less than N candidates can be derived from the previous steps, continue searching remaining number of N candidates from first available uni-prediction list-1 candidates among multiple blocks according to the searching order. Once up-to-N available candidate(s) are found, they are used to derive the Merge candidate (or MVP).

In another embodiment, N (N equal to a positive integer) above spatial MVP(s) or Merge candidate(s) are derived from the above boundary until first N available candidate are found. As shown in FIG. 7, the searching order among the multiple blocks can be one of the followings:

1. (B_{(m+1)/2-1}, B_{(m+1)/2}, . . . , B₁, Bₘ)

2. (B_{(m+1)/2-1}, B_{(m+1)/2}, . . . , B₁, Bₘ, B₀)

3. (B_{(m+1)/2-1}, B_{(m+1)/2}, . . . , B₁, Bₘ, B₀, Bₘ₊₁)

4. (B_{(m+1)/2}, B_{(m+1)/2-1}, . . . , Bₘ, B₁)

5. (B_{(m+1)/2}, B_{(m+1)/2-1}, . . . , Bₘ, B₁, Bₘ₊₁)

6. (B_{(m+1)/2}, B_{(m+1)/2-1}, . . . , Bₘ, B₁, B₀)

7. (B_{(m+1)/2}, B_{(m+1)/2-1}, . . . , Bₘ, B₁, Bₘ₊₁, B₀)

8. (B₁→ . . . →Bₘ)

9. (B₀, B₁→ . . . →Bₘ)

10. (Bₘ→ . . . →B₁)

11. (Bₘ→ . . . →B₀)

12. (B₁→ . . . →Bₘ₊₁)

13. (B₀, B₁→ . . . →Bₘ₊₁)

14. (Bₘ₊₁→ . . . →B₁)

15. (Bₘ₊₁→ . . . →B₀)

In another embodiment, N (N equal to a positive integer) above spatial MVP(s) or Merge candidate(s) are derived from the above boundary until first N available candidate are found with a given priority order. As shown in FIG. 7, the searching order among the multiple blocks can be one of the followings:

1. (B_{(m+1)/2-1}, B_{(m+1)/2}, . . . , B₁, Bₘ)

2. (B_{(m+1)/2-1}, B_{(m+1)/2}, . . . , B₁, Bₘ, B₀)

3. (B_{(m+1)/2-1}, B_{(m+1)/2}, . . . , B₁, Bₘ, B₀, Bₘ₊₁)

4. (B_{(m+1)/2}, B_{(m+1)/2-1}, . . . , Bₘ, B₁)

5. (B_{(m+1)/2}, B_{(m+1)/2-1}, . . . , Bₘ, B₁, Bₘ₊₁)

6. (B_{(m+1)/2}, B_{(m+1)/2-1}, . . . , Bₘ, B₁, B₀)

7. (B_{(m+1)/2}, B_{(m+1)/2-1}, . . . , Bₘ, B₁, Bₘ₊₁, B₀)

8. (B₁→ . . . →Bₘ)

9. (B₀, B₁→ . . . →Bₘ)

10. (Bₘ→ . . . →B₁)

11. (Bₘ→ . . . →B₀)

12. (B₁→ . . . →Bₘ₊₁)

13. (B₀, B₁→ . . . →Bₘ₊₁)

14. (Bₘ₊₁→ . . . →B₁)

15. (Bₘ₊₁→ . . . →B₀)

Another embodiment of the spatial MVP or Merge candidate search within the multiple searching blocks according the present invention is described as follows:
Search first N (N equal to a positive integer) available bi-direction candidate(s) among multiple blocks according to the searching order. Once up-to-N available candidates are found, they are used to derive the Merge candidate (or MVP).
If less than N candidates can be derived from the previous step, continue searching remaining number of N candidates from first available uni-prediction list-0 candidate(s) among multiple blocks according to the searching order. Once up-to-N available candidates are found, they are used to derive the Merge candidate (or MVP).
If still less than N candidates can be derived from the previous steps, continue searching remaining number of N candidates from first available uni-prediction list-1 candidate(s) among multiple blocks according to the searching order. Once up-to-N available candidates are found, they are used to derive the Merge candidate (or MVP).

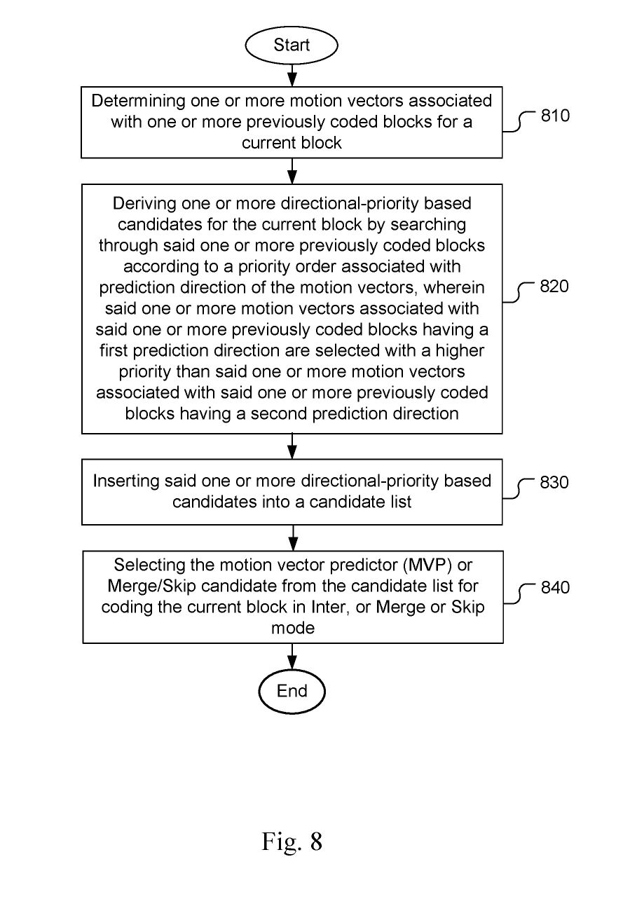

FIG. 8 illustrates an exemplary flowchart of a coding system incorporating directional-priority based candidate derivation for Inter, Merge or Skip mode according to an embodiment of the present invention. The system determines one or more motion vectors associated with one or more previously coded blocks for a current block in step 810. The motion vectors can be derived at an encoder side or parsed from a bitstream in a decoder side. The system then derives one or more directional-priority based candidates for the current block by searching through said one or more previously coded blocks according to a priority order associated with prediction direction of the motion vectors as shown in step 820. The motion vectors associated with the previously coded blocks having a first prediction direction are selected with a higher priority than the motion vectors associated with the previously coded blocks having a second prediction direction. In step 830, said one or more directional-priority based candidates are inserted into a candidate list. The motion vector predictor (MVP) or Merge/Skip candidate is selected from the candidate list for coding the current block in Inter, or Merge or Skip mode in step 840.

The flowchart shown above is intended to illustrate examples of directional-priority based candidate derivation according an embodiment of the present invention. A person skilled in the art may modify each step, re-arranges the steps, split a step, or combine steps to practice the present invention without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more electronic circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of deriving a motion vector predictor (MVP) or Merge/Skip candidate for a block coded in Inter, or Merge or Skip mode, the method comprising:
determining one or more motion vectors associated with one or more previously coded blocks for a current block;
deriving one or more directional-priority based candidates for the current block by searching through said one or more previously coded blocks according to a priority order associated with prediction direction of the motion vectors, wherein said one or more motion vectors associated with said one or more previously coded blocks having a first prediction direction are selected with a higher priority than said one or more motion vectors associated with said one or more previously coded blocks having a second prediction direction;
inserting said one or more directional-priority based candidates into a candidate list; and
selecting the motion vector predictor (MVP) or Merge/Skip candidate from the candidate list for coding the current block in Inter, or Merge or Skip mode.

2. The method of claim 1, wherein said one or more previously coded blocks comprise one or more top neighboring blocks in a top boundary of the current block, one or more left neighboring blocks in a left boundary of the current block, or both said one or more top neighboring blocks in the top boundary of the current block and said one or more left neighboring blocks in the left boundary of the current block.

3. The method of claim 2, wherein said one or more directional-priority based candidates comprises one or more top directional-priority based candidates derived from said one or more top neighboring blocks, one or more left directional-priority based candidates derived from said one or more left neighboring blocks, or both said one or more top directional-priority based candidates derived from said one or more top neighboring blocks and said one or more left directional-priority based candidates derived from said one or more left neighboring blocks.

4. The method of claim 3, wherein said one or more top directional-priority based candidates are derived by searching said one or more top neighboring blocks from right to left or from left to right.

5. The method of claim 3, wherein said one or more top directional-priority based candidates are derived by searching said one or more top neighboring blocks from a center top neighboring block toward both end top neighboring blocks in an alternated manner.

6. The method of claim 3, wherein said one or more left directional-priority based candidates are derived by searching said one or more left neighboring blocks from top to bottom or from bottom to top.

7. The method of claim 3, wherein said one or more left directional-priority based candidates are derived by searching said one or more left neighboring blocks from a center left neighboring block toward both end left neighboring blocks in an alternated manner.

8. The method of claim 2, wherein said one or more directional-priority based candidates comprises one top directional-priority based candidate derived from said one or more top neighboring blocks and one left directional-priority based candidate derived from said one or more left neighboring blocks.

9. The method of claim 8, wherein said one or more top neighboring blocks correspond to a single center top neighboring block in a center top boundary of the current block, and said one or more left neighboring blocks correspond to a single center left neighboring block in a center left boundary of the current block.

10. The method of claim 1, wherein the prediction direction comprises bi-direction, list-0 and list-1, and the priority order associated with the prediction direction corresponds to highest priority for the bi-direction, middle priority for the list-0 and lowest priority for the list-1.

11. The method of claim 1, wherein the prediction direction comprises bi-direction, list-0 and list-1, and the priority order associated with the prediction direction corresponds to highest priority for the bi-direction, middle priority for a given target reference list and lowest priority for other list when a preferred target reference list is given.

12. The method of claim 1, wherein the prediction direction comprises bi-direction and uni-direction, the first prediction direction is the bi-direction, and the second prediction direction is the uni-direction.

13. The method of claim 1 further comprising inserting one or more spatial candidates, one or more temporal candidates, or both into the candidate list.

14. The method of claim 13, wherein the candidate list comprises one top directional-priority based candidate derived from one or more top neighboring blocks of the current block, one left directional-priority based candidate derived from one or more left neighboring blocks of the current block, and five spatial candidates.

15. The method of claim 14, wherein the candidate list further comprises four temporal candidates derived from collocated blocks.

16. The method of claim 13, wherein the candidate list is pruned before, during or after said inserting said one or more spatial candidates, said one or more temporal candidates, or both into the candidate list to remove one or more redundant candidates.

17. The method of claim 1, wherein candidate indices for candidate members of the candidate list are coded using context-adaptive binary arithmetic coding (CABAC).

18. The method of claim 17, wherein each bin of the candidate indices is context coded with an own probability status of each bin.

19. The method of claim 1, wherein the directional-priority based candidate is a first available bi-directional candidate within a searching range.

20. An apparatus for deriving a motion vector predictor (MVP) or Merge/Skip candidate for a block coded in Inter, or Merge or Skip mode, the apparatus comprising one or more electronic circuits configured to:
determine one or more motion vectors associated with one or more previously coded blocks for a current block;
derive one or more directional-priority based candidates for the current block by searching through said one or more previously coded blocks according to a priority order associated with prediction direction of the motion vectors, wherein said one or more motion vectors associated with said one or more previously coded blocks of the current block having a first prediction direction are selected with a higher priority than said one or more motion vectors associated with said one or more previously coded blocks of the current block having a second prediction direction;
insert said one or more directional-priority based candidates into a candidate list; and
select the motion vector predictor (MVP) or Merge/Skip candidate from the candidate list for coding the current block in Inter, or Merge or Skip mode.
